(19) United States
(12) Patent Application Publication
(10) Pub. No.: US 2011/0059205 A1
(43) Pub. Date: Mar. 10, 2011

(54) BOTANICAL EXTRACTS AND FLAVOR SYSTEMS AND METHODS OF MAKING AND USING THE SAME

(76) Inventors: Sylvia Gaysinsky, Bicester (GB); Roger Michael Browning, Buckinghamshire (GB)

(21) Appl. No.: 12/876,124

(22) Filed: Sep. 4, 2010

Related U.S. Application Data
(60) Provisional application No. 61/240,075, filed on Sep. 4, 2009.

(51) Int. Cl. A23L 2/56; A23L 1/221; A23L 3/34; A23C 9/156; A23F 5/00; A23F 3/00; A23L 2/38; A23L 2/02; A23L 1/222

(52) U.S. Cl. 426/66; 426/650; 426/532; 426/590; 426/580; 426/594; 426/597; 426/599; 426/431; 426/506

(57) ABSTRACT

Methods for preparing a botanical extract and a flavor system comprising a botanical extract produced by the process for use in beverages are provided. Also provided is a flavor system comprising a botanical extract comprising at least one of thymol, eugenol, carvacrol, cinnamic aldehyde, and eucalyptol. Further provided is a flavor system having a minimum inhibitory concentration of less than about 3%.

### CROSS-REFERENCE TO RELATED APPLICATIONS

This application claims priority to U.S. Provisional Application No. 61/240,075, filed Sep. 4, 2009, which is incorporated herein by reference.

### BACKGROUND

Beverages having unique and favorable properties are sought. Additionally, new ways to preserve beverages are sought.

### SUMMARY

The present application provides a method of producing a botanical extract and also a flavor system that can provide both antimicrobial benefits with pleasant organoleptic properties for use in beverages.

In one aspect, the application provides a flavor system comprising at least one of an emulsion, microemulsion or nanoemulsion comprising an herbal extract, wherein the herbal extract comprises at least one of thymol, cinnamic aldehyde, eugenol, carvacrol, eucalyptol, and a combination thereof.

In another aspect, the application provides a flavor system comprising an herbal extract having a minimum inhibitory concentration for at least one of Porphyromonas gingivalis, Actinomyces viscosus, Actinomyces naeslundii, Streptococcus mutans, Zygosaccharomyces Bailii, Saccharomyces cerevisiae, Brettanomyces bruxellensis, Alicyclobacillus acidoterrestris, and Fusobacterium nucleatum, wherein the minimum inhibitory concentration is less than about 3%.

In another aspect, the application provides a method of making a beverage product comprising a) treating an herb with liquid CO₂ extraction to produce an herbal extract; and b) combining the herbal extract with at least one of water, emulsifier, and surfactant to form a beverage product.

In yet another aspect, the application provides a method of making a flavor system, the method comprising combining a water phase and an oil phase comprising an herbal extract under conditions sufficient to form at least one of an emulsion, a microemulsion and nanoemulsion.

### BRIEF DESCRIPTION OF DRAWINGS

FIG. 1 is a schematic diagram of a botanical extract system, including treating a botanical to a low temperature liquid CO₂ extraction process in the presence of ethanol.

FIG. 2 is a schematic diagram of a liquid CO₂-alcohol extraction process.

FIG. 3 is a schematic diagram of a process to remove alcohol from an alcohol-botanical extract resulting from a liquid CO₂-alcohol extraction process, using low vacuum distillation.

FIG. 4 is a schematic diagram of a molecular distillation process to produce a final botanical extract that is a concentrated distillate.

FIG. 5 is a graph of percent release of Marker 1, thymol, and Marker 2, menthol, from chewing gum versus time, to monitor flavor release.

### DETAILED DESCRIPTION

Before any embodiments of the application are explained in detail, it is to be understood that the application is not limited in its application to the details of construction and the arrangement of components set forth in the following description or illustrated in the following drawings. The application is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It also is understood that any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

The application provides a process of making a botanical extract. Botanicals include plants and herbs. The botanical extract may be derived from thyme, oregano, cilantro, ginger, lavender, allspice, basil, bay, celery seed, pimento, lemongrass, parsley, onion, mustard, tarragon, sage, rosemary, coriander, marjoram, cumin, fennel, cinnamon, clove, black peppercorn, cassia bark, allspice, nutmeg, grape seed, green tea, Oolong tea, pine bark, hops, pomegranate extract containing punicic acid, and the like. Other suitable extracts are described in U.S. patent application Ser. No. 12/399,295, filed Mar. 6, 2009, which is hereby incorporated by reference in its entirety. One particularly suitable botanical extract comprises thyme. Other particularly suitable botanical extracts include, but are not limited to, cassia bark, clove and allspice. The botanical extract may comprise a mixture of compounds, both active and inactive in providing antimicrobial efficacy and flavor. In a suitable embodiment, the application provides a process that produces a botanical extract with unique flavoring and antimicrobial properties. The process for obtaining natural botanical extracts includes sub-critical CO₂ extractions with or without an extra distillation such as molecular distillation and/or column distillation. The process generally may include at least one of the following: (1) a first low temperature liquid CO₂-alcohol extraction process; (2) a low vacuum distillation process; and (3) a molecular distillation process. The combination of these steps provides a highly concentrated, low color, high flavor botanical extract with antimicrobial activity.

The application also provides a flavor system for the addition to compositions of oral products such as toothpaste, mouth rinse, gums, lozenges, and the like. The flavor systems may also be useful in conjunction with beverages as set forth below. The flavor system comprises a botanical extract. The flavor system may also include at least one characterizing flavor component, such as a flavor oil. The flavor system may include a second characterizing flavor component, such as menthol crystals. One suitable embodiment of the flavor system comprises thyme extract, peppermint oil and menthol crystals. The compositions are suitably non-toxic and have antimicrobial activity.

In another aspect, the application provides a flavor system that provides antimicrobial activity, wherein the antimicrobial activity is measured by a minimum inhibitory concentration. The flavor system comprises a botanical extract, and has a minimum inhibitory concentration that is less than about 3%, less than about 2%, less than about 1%, less than about 0.5%, less than about 0.3%, less than about 0.2%, less than about 0.1%, less than about 0.05% for at least one of Porphyromonas gingivalis, Actinomyces viscosus, Actinomyces naeslundii, Streptococcus mutans, Fusobacterium nucleatum, Zygosaccharomyces bailii, Saccharomyces cerevisiae, and Alicyclobacillus acidoterrestis.

In yet another aspect, the application provides beverages comprising a flavor system including a botanical extract having antimicrobial activity and at least one characterizing flavor component.

In one aspect, the application provides a method for producing a botanical extract. The method comprises 1) extracting an alcohol-botanical extract from the botanical using a liquid CO₂-alcohol (e.g., ethanol) extraction at temperatures less than about 25° C.; 2) distilling the alcohol-botanical extract under vacuum to remove at least a portion of the alcohol and produce a first botanical extract; and 3) molecularly distilling the first botanical extract to produce a second botanical extract. Alternatively or in addition to extraction by liquid CO₂-alcohol, extract may also be obtained by liquid CO₂+propylene glycol and/or liquid CO₂+medium chain triglycerides (MCT). Alternatively, extraction may be accomplished by liquid CO₂ alone. In these cases, molecular distillation may or may not be used.

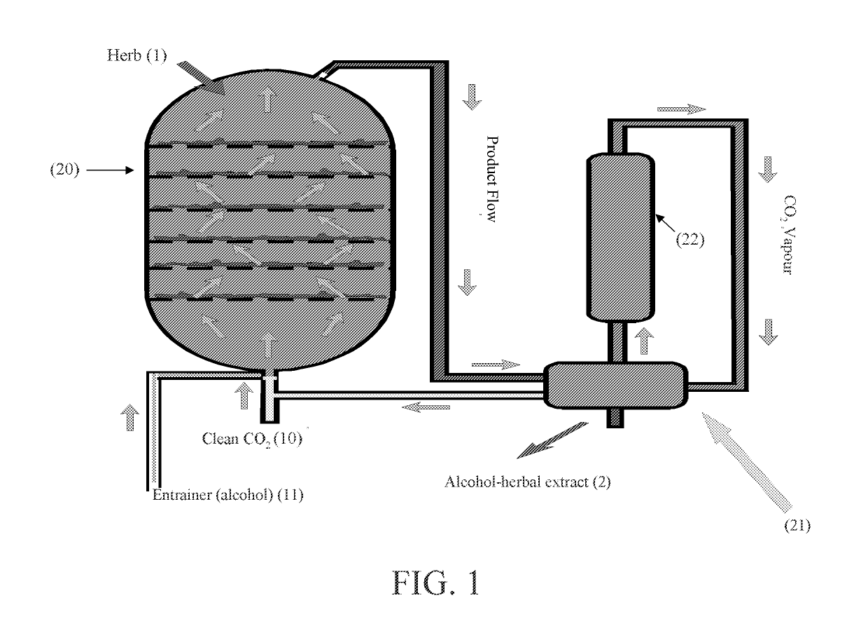

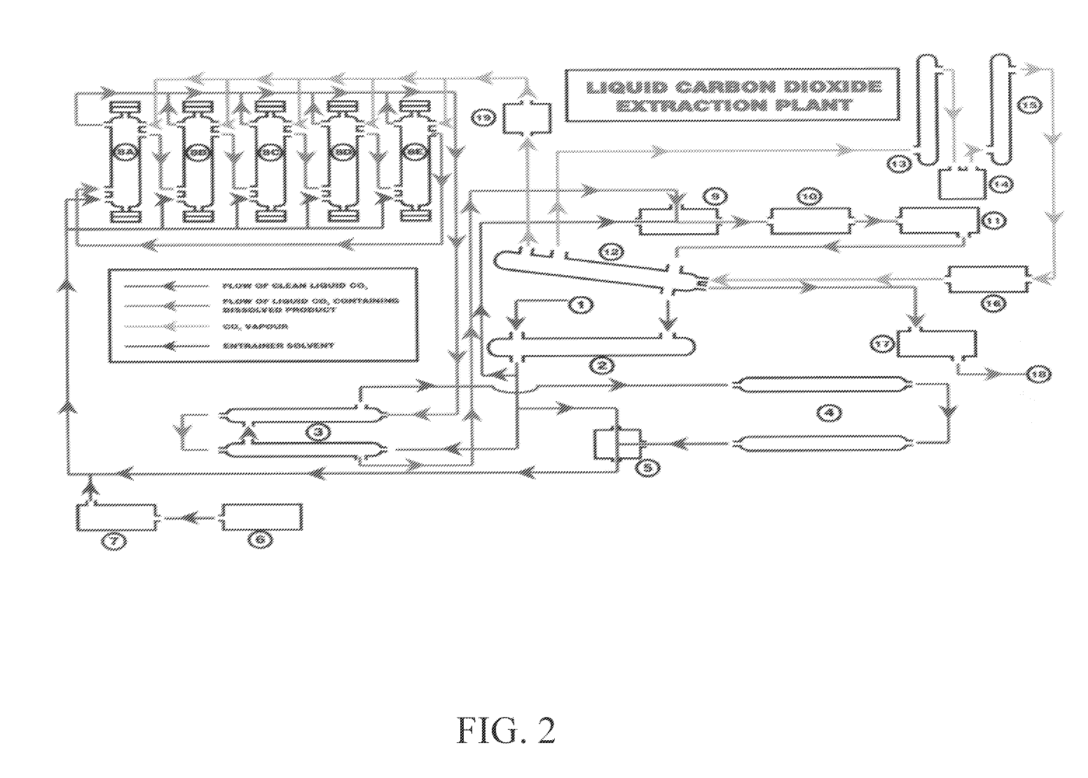

The first step includes treating the botanical to a low temperature liquid CO₂ extraction process in the presence of ethanol. This process is illustrated in FIG. 1 and FIG. 2.

Dry botanicals (1) are milled on a hammermill with an about 1 millimeter to about 7 millimeter screen to increase the surface area and rupture the botanical. The botanical is blended with at least about 10%, at least about 15%, at least about 20%, at least about 25%, or at least about 30% of its own weight of de-ionized water, using a ribbon mixer or similar equipment until homogenous, e.g., about 5 minutes. The dampened botanical material (1) is packed into a series of extraction columns (20). The columns are treated by dynamic flow of liquid carbon dioxide (10) injected with alcohol (11) as a co-extraction entrainer. In a suitable embodiment, the amount of CO₂-alcohol used can be measured as a mean flow rate through the extraction column. Suitable flow rates include at least about 150 kg/hr, at least about 175 kg/hr, at least about 200 kg/hr, at least about 222 kg/hr, or at least about 240 kg/hr. The flow rate may be less than about 350 kg/hr, less than about 325 kg/hr, less than about 300 kg/hr, less than about 275 kg/hr, or less than about 260 kg/hr.

The ratio of CO₂ to alcohol may vary according to the botanical being processed. In a suitable embodiment, the alcohol is provided in at least about 0.1%, at least about 0.2%, at least about 0.3%, at least about 0.5%, at least about 0.7%, at least about 1.0%, or at least about 2.0% by weight in the liquid CO₂. In a suitable embodiment, the alcohol is provided at a mean flow rate of 1 kg/hr with the CO₂ provided at a mean flow rate of 250 kg/hr. In one embodiment, the alcohol is ethanol.

The CO₂-alcohol is provided to the extraction columns under pressure, the pressure being at least about 35 atmosphere, at least about 40 atmosphere, at least about 45 atmosphere, at least about 50 atmosphere, at least about 55 atmosphere, or at least about 60 atmosphere, wherein a suitable range is about 45-55 atmosphere. The process is driven by an approximately 10 atmosphere differential within the plant during operation.

In certain embodiments, this process is carried out at temperatures that are less than about 25° C., less than about 20° C., less than about 15° C., less than about 12° C. Suitably the temperature may be between about 0° C. and about 10° C. In a suitable embodiment, the temperature is about 7° C.+1° C. These temperatures are below the temperatures used in supercritical CO₂ extraction which occur above the critical temperature 31° C., and more typically at 40-60° C., and very often higher. The lower temperatures concentrate more of the volatile components in the extract and avoid the decomposition of components. The liquid CO₂ phase extraction is more selective for more volatile components and therefore achieves higher concentrations of them.

The liquefied carbon dioxide-alcohol is a unique solvent mixture that dissolves the low molecular weight organoleptically active components of the botanical. The low temperature and pressurized system prevents the degradation and loss of volatiles which may typically occur with a traditional essential oil distillation process, while higher molecular weight unwanted materials such as heavier fats, waxes, pigments, sugars, starches and tannins are excluded by this extraction process. The CO₂-alcohol-botanical extract solution emerging from the extraction columns is passed to a heat exchanger (21) where the temperature is raised a few degrees within the closed system, and the CO₂ is changed to vapor by the change in temperature and removed via pipe work to the compressor for recycling to liquid CO₂ through the process. The alcohol-extract is collected from the system as a cold foam product, and as the foam warms to room temperature any residual CO₂ vaporizes and leaves the alcohol-botanical extract (2). The time of extraction depends on the material used and can be readily determined by one of ordinary skill in the art. For a thyme extract, the extraction time per extraction column filled with thyme leaves (about at least 25 kg, more suitably 28 kg) is at least about 4 hours.

FIG. 2 charts a description of the CO₂-alcohol extraction process in detail. Liquid CO₂ 1 enters the system into a liquid CO₂ holding tank 2. The CO₂ is processed through a heat exchanger 3 and a refrigeration unit 4 to provide the liquid CO₂ at the desired temperature of about 7° C. The liquid CO₂ is injected with alcohol from an alcohol storage tank 6 via a co-entainer pump 7. The liquid CO₂-alcohol solvent is pumped through a set of extraction columns 8A-E which hold the milled botanical leaves. The liquid CO₂-alcohol-botanical extract is processed through the heat exchanger 3 (giving an initial input of energy into the extract) to an automatic mixing valve 9, an automatic flow control valve 10 and filters 11 into a main condenser-heat exchanger 12 where the CO₂ is recycled back into the CO₂ holding tank 2 and the product is collected via the product collection pump 17 to a product tap 18. CO₂ is also purified to be reused and recovered from the condenser-heat exchanger 12 through a demisting filter 13, a compressor 14, a de-oil misting filter 15 and at a vapor temperature control 16. A vaporizer 19 pumps warm vapor back into the extraction columns 8.

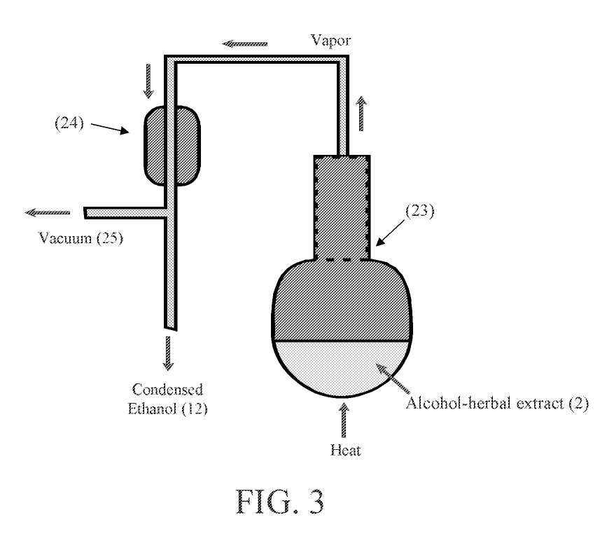

A second step of the process includes processing the alcohol-botanical extract from the extraction through a low vacuum distillation process to remove the alcohol as depicted in FIG. 3 and form a first botanical extract (3). This process can be carried out using a suitable vacuum still (23). The alcohol is removed under low vacuum distillation at typically a temperature of at least about 20° C., at least about 30° C., at least about 35° C., at least about 40° C., at least about 45° C., at least about 50° C., at least about 55° C., or at least about 60° C., one suitable range is between about 30 to about 40° C., finishing at a maximum of about at least 60° C., to reduce the alcohol content to a residual level. Residual alcohol may be less than about 25%, less than about 20%, less than about 15%, or less than about 10%. The residual alcohol may be at least about 0.05%, at least about 0.1%, at least about 0.2%, at least about 0.5%, at least about 1%, at least about 2%, or at least about 5%.

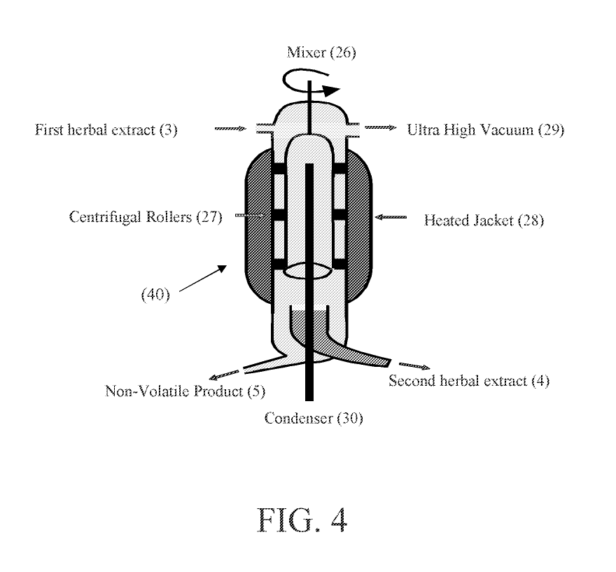

A third step of the process includes a molecular distillation process. A falling-film short path still may be used. Suitable stills such as models KD5 or KD10 Molecular Stills are available from UIC GmbH of Germany. This step of the process is depicted in FIG. 4. This special design of the still subjects the material being processed to heating for the briefest possible time while allowing a very high vacuum to be achieved, lowering the vaporizing temperature and thus greatly limiting the overall exposure of the extract. Suitably, the liquid extract (3) is continuously feed into the still (40) and passes down the inside of a heated jacket (28), which is at about at least 80° C., at least about 90° C., or at least about 100° C., as a thin film produced by the centrifugal force of the rotating rollers (27), and falls by gravity to be collected. This process is carried out under high vacuum conditions, wherein the pressure is suitably at least about 5×10⁻⁴ mbar, at least about 1×10⁻³ mbar, at least about 1.5×10⁻³ mbar, or at least about 2×10⁻³ mbar. The pressure is suitably at least less than about 1×10⁻² mbar, less than about 5×10⁻² mbar, less than about 7×10⁻² mbar, or less than about 1×10⁻³. The extract is subjected to heat typically for only a few minutes. Suitably, the extract passes through the system at a rate of about at least 1 kg/hr, at least about 2 kg/hr, at least about 3 kg/hr, at least about 5 kg/hr, at least about 7 kg/hr, at least about 8 kg/hr, or at least about 10 kg/hr. In a suitable embodiment, the rate is about 1 to about 2 kg/hr for a KD10 Molecular Still. The volatile material passes as a laminar flow of vapor across a very short path onto a condenser (30) which is concentric at the center of the roller assembly, and falls by gravity into a receiver. This laminar flow, coupled with the use of high efficiency rotary and oil diffusion vacuum pumps and a liquid nitrogen trap at −200° C. allows vacuum pressures down to 10⁻⁶ atmosphere to be achieved. Materials in the extract that would be damaged or even decomposed during traditional distillation are separated and purified into the final botanical extract. This process produces a second botanical extract (4) that is a concentrated distillate with reduced color.

As mentioned above, the application also provides a flavor system comprising the botanical extract. The botanical extract is suitably provided as at least about 1% wt/wt, at least about 2% wt/wt, at least about 4% wt/wt, at least about 6% wt/wt, at least about 9% wt/wt, at least about 15% wt/wt, at least about 20% wt/wt, or at least about 25% wt/wt of the flavor system. The botanical extract is suitably provided as less than about 30% wt/wt, less than about 20% wt/wt, less than about 15% wt/wt, less than about 12% wt/wt of the flavor system.

One suitable botanical extract is a thyme extract derived from dry thyme by the process described above. The thyme extract is a mixture of compounds, both active and inactive in providing antimicrobial efficacy and flavor. Suitable processes produce thyme extract with unique flavoring and antimicrobial properties. This thyme extract has unique and beneficial properties from thyme oils produced by other known methods. The main active ingredients of the thyme extract that provide antimicrobial efficacy include thymol, eugenol, carvacrol and eucalyptol. Thyme extract also includes a number of inactive ingredients, some of which can be found in Table 7. The unique chemical composition of this extract provides the unique flavor, color and antimicrobial properties. The thyme extract provides a more appealing flavor in addition to antimicrobial benefits. One example of a suitable thyme extract is THYME SNO™ available from Sensient Flavors, Inc. (Indianapolis, Ind.).

The herbal extract may comprise at least one active ingredient, examples of which include, but are not limited to, those listed in Table 13, used, alone or in combination. For example, active ingredients or compounds in the herbal extract may include at least one of cinnamic aldehyde, p-cymene, eugenol, carvacrol, cineol, methyl ether cineol, d-linalool, thymol, a-pinene, d-a-pinene, b-pinene, polymeric polyphenol, methyl chavioc, geraniol, l-linalool, piperine, catechins (ECG, EGCG), teaflavins, carvone, limonene, d-limonene, cariofilene, amine fraction, cuminaldehyde, p-cymene, diallyl disulfide allicin, diethyl sulfide, diallyl trisulfate, gingerols, activin, nerolidol, caryophillene, humulones, lupulones, menthol, p-cymene, eucalyptol, allyl-isothiocyanate, d-n-propyl disulfide, methyl-n-propyl disulfide, borneol, cineol, camphor, a-pinene, bornyl acetate, thujone, vanillin, p-courmaric acid, p-hydroxbenzoic, and a combination thereof. The herbal extract may comprise about 0.01% to about 80% active ingredient. The herbal extract may comprise less than about 80%, less that about 75%, or less than about 60% active ingredient. The herbal extract may comprise greater than about 0.05%, greater than about 20%, or greater than about 40% active ingredient. For example, cassia bark may contain about 80% cinnamic aldehydes; allspice may contain about 75% eugenol.

The flavor system may also include at least one characterizing flavor component that provides organoleptic properties of pleasant taste and smell, and may provide additional antimicrobial activity as well. A first characterizing flavor component may constitute suitably at least about 5%, at least about 10%, at least about 20%, at least about 30%, at least about 47%, at least about 50%, at least about 60%, or at least about 70% wt/wt of the flavor system. The first characterizing flavor component may constitute less than about 70% wt/wt, less than about 60% wt/wt, less than about 55% wt/wt, less than about 50% wt/wt, less than about 40% wt/wt, or less than about 20% wt/wt of the flavor system. The first characterizing flavor component may be a flavor oil. Examples of flavor oils that may be used include, but are not limited to, peppermint oil, spearmint oil, oil of wintergreen, lavender oil, rosemary oil, clove oil and cinnamon oil.

The flavor system may also include a second characterizing flavor component. The flavor system may suitably includes at least about 5%, at least about 10%, at least about 20%, at least about 30%, at least about 40%, at least about 50% wt/wt, at least about 60% wt/wt, or at least about 70% wt/wt of the secondary flavor component. The flavor system may suitably include less than about 70%, less than about 60%, less than about 50%, less than about 40%, less than about 30%, less than about 20%, less than about 15%, or less than about 10% of the secondary flavor component. One example of a secondary flavor component includes, but is not limited to, menthol crystals, C₁₀H₂₀O, which are an organic compound made synthetically or obtained from mint oils, most commonly produced from Mentha arvensis. Menthol is a waxy, clear or white crystalline substance commercially available from Monarchy Aromatics, Ltd.

Additional examples of first and second characterizing flavor components may be from oils, crystals, liquid concentrates, synthetic flavors, or combinations thereof. Additional characterizing flavor components may include, but are not limited to, oils derived from plants and fruit such as citrus oils, fruit essences, peppermint oil, spearmint oil, other mint oils, clove oil, oil of wintergreen, cinnamon, anise, artificial flavoring agents such aldehyde flavors including, but are not limited to, acetaldehyde (apple), benzaldehyde (cherry, almond), anisic aldehyde (licorice, anise), cinnamic aldehyde (cinnamon), citral, i.e., alpha citral (lemon, lime), neral, i.e., beta citral (lemon, lime), decanal (orange, lemon), ethyl vanillin (vanilla, cream), heliotropine, i.e., piperonal (vanilla, cream), vanillin (vanilla, cream), alpha-amyl cinnamaldehyde (spicy fruity flavors), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., Melonal (melon), 2,6-dimethyloctanal (green fruit), and, 2-dodecenal (citrus, mandarin). Those skilled in the art will recognize that natural and artificial secondary flavor components may be combined in any sensorally acceptable fashion. All such flavors and flavor blends are contemplated by the present application.

As mentioned above, the application also provides a flavor system comprising a botanical extract. “Antimicrobial activity,” as described herein, is the ability of a botanical extract to retard the growth of and/or prevent the growth of at least one bacteria, yeast, or other microbe. Examples of representative gram-positive and gram-negative oral bacteria and microbes include, but are not limited to, Actinmoyces viscosus, Actinomyces naeslundii, Fusobacteriumm nucleatum, Porphyromonas gingivalis, and Streptococcus mutans. Examples of bacteria responsible for spoilage of beverages include, but are not limited to, Streptococcus sanguis, Zygosaccharomyces bailii, Brettanomyces bruxellensis, Saccharomyces cerevisiae, and Alicyclobacillus acidoterrestis. In certain embodiments, the botanical extracts may have anti-microbial activity against at least one of Zygosaccharomyces bailii, Brettanomyces bruxellensis, Saccharomyces cerevisiae, and Alicyclobacillus acidoterrestis, or a combination thereof. Anti-microbial activity can be measured by the minimum inhibitory concentration of the agent. The minimum inhibitory concentration of a botanical extract is the concentration of the extract within a test sample at which no bacterial growth is observed. The test sample may be saliva or a suitable bacterial culture. In the examples below, the minimum inhibitory concentration is provided as a percentage.

The minimum inhibitory concentration for the botanical extract is measured as a percent volume (e.g., 1% would be one part flavor system in 99 parts test sample) as described in the example below. The botanical extract may provide antimicrobial activity as measured by minimum inhibitory concentration (MIC) of at least about 0.01%, at least about 0.05%, at least about 0.1%, at least about 0.2%, at least about 0.5% for bacteria or other microbes such as oral bacteria. The botanical extract may provide antimicrobial activity as measured by minimum inhibitory concentration of less than about 5%, less than about 3%, less than about 2%, less than about 1%, less than about 0.5%, less than about 0.3%, less than about 0.2%, less than about 0.1% for a bacteria and/or yeast.

The flavor system may include additional antimicrobial agents. Suitable antimicrobial agents include, but are not limited to, cedarwood oil, chloramphenicol, berberine, Glycyrrhiza glabra extract, juicy fruit basil oil, juniper berries oil, lemon basil oil, orally active metallic ion such as salts of zinc, tin, silver and copper, hexylresorcinol, cetylpyridinium chloride, chlorhexidine digluconate, 5-chloro-2-(2,4-dichlorophenoxy)phenol, commonly referred to as triclosan, phthalic acid and its salts including, but not limited to those disclosed in U.S. Pat. No. 4,994,262, substituted monoperthalic acid and its salts and esters as disclosed in U.S. Pat. Nos. 4,990,329, 5,110,583, and 4,716,035, magnesium monoperoxy phthalate, chlorhexidine (Merck Index, no. 2090), alexidine (Merck Index, no. 222, hexetidine (Merck Index, no. 4624), sanguinarine (Merck Index, no. 8320), benzalkonium chloride (Merck Index, no. 1066), salicylanilide (Merck Index, no. 8299), domiphen bromide (Merck Index, no. 3411), cetylpyridinium chloride (CPC) (Merck Index no. 2024, tetradecylpyridinium chloride (TPC), N-tetradecyl-4-ethyllpyridinium chloride (TDEPC), octenidine, delmopinol, octapinol, and other piperidino derivatives, niacin preparations, zinc/stannous ion agents, antibiotics such as augmentin, amoxicillin, tetracycline, doxycycline, minocycline, and metronidazole; and analogs and salts of the above; essential oils including thymol, geraniol, carvacrol, citral, hinokitiol, eucalyptol, catechol (particularly 4-allyl catechol) and mixtures thereof; methyl salicylate; hydrogen peroxide; metal salts of chlorite and mixtures of all of the above. Each of the patents recited herein are hereby fully incorporated by reference.

Sweeteners may also be included in the flavor system. Suitable sugar sweeteners include, but are not limited to, sucrose, dextrose, maltose, dextrin, dried invert sugar, fructose, glucose, galactose, corn syrup solids, stevioside, Lo-Han Guo, and the like, alone or in combination. Sugarless sweeteners include, but are not limited to, sugar alcohols such as sorbitol, mannitol, xylitol, hydrogenated starch hydrolysates, maltitose, and the like, alone or in combination. High intensity artificial sweeteners can also be used alone or in combination with other sweeteners. These sweeteners include, but are not limited to, sucralose, aspartame, MAPM derivatives such as neotame, salts of acesulfame, altitame, saccharin and its salts, cyclamic acid and its salts, glycyrrhizinate, dihydrochalcones, thaumatin, monellin, and the like, alone or in combination.

In one embodiment, the flavor systems are manufactured by mixing a first characterizing flavor component (e.g., peppermint oil) with a second characterizing flavor component (e.g., menthol crystals) and heating the mixture to at least about 35° C., to at least about 40° C., to at least about 45° C., to at least about 50° C., to at least about 55° C., to at least about 60° C., to at least about 65° C. until the second characterizing flavor component is melted in a standard mixer. The mixture is mixed until homogenous and then cooled. The botanical extract is added to the mixture and mixed until homogenous. In another embodiment, the botanical extract may be added to a first characterizing flavor component without the use of a second flavoring component and mixed until homogenous. The botanical extract and first characterizing flavor component may be mixed at room temperature. Other flavors may also be added and mixed until homogenous.

The flavor systems may be used in the preparation of spray dried flavor compositions. The flavor systems may be combined with encapsulating agents such as the starch-based encapsulating agent Hi-Cap 100 from National Starch (Bridgewater, N.J., U.S.A.) and water. Other suitable encapsulating agents may include N-Lok® 1930, CAPSUL®, CAPSUL®TA (all from National Starch), and EmCap® (from Cargill, Inc., Cedar Rapids, Iowa, U.S.A.). The water and starch-based encapsulating agent may be mixed, and a flavor system may be added to the starch and water mixture to form an emulsion. The emulsion may be dried with an inlet temperature of about 160° C. The encapsulating agent may be present in amounts of at least about 5%, at least about 10%, at least about 20%, at least about 30%, at least about 40%, or at least about 50% by weight of the total spray dried flavor composition. The encapsulating agent may be present in a suitable amount less than about 50%, less than about 40%, less than about 20%, less than about 10%, or less than about 5% by weight of spray dried flavor composition. The flavor system may be added to amounts of at least about 0.5%, at least about 0.8%, at least about 1%, at least about 2%, at least about 4%, at least about 6%, at least about 10%, at least about 20%, at least about 30%, at least about 40%, at least about 50%, at least about 60%, or at least about 70% by weight of the total spray dried flavor composition. The flavor system may be used in the composition in a suitable amount less than about 60%, less than about 50%, less than about 20%, less than about 12%, less than about 10%, less than about 7%, less than about 5%, less than about 3%, or less than about 2% by weight of spray dried flavor composition. The spray dried flavor formulations may be used with or without other flavor systems and may be incorporated into compositions such as beverages, water, chewing gums, toothpaste, mouth rinse, liquid dentifrice, lozenges, liquid spray, and edible films.

The flavor systems may be used in the preparation of oral compositions for oral products by the addition of the flavor system at amounts of at least about 0.5%, at least about 0.8%, at least about 1%, at least about 2%, at least about 4%, at least about 6%, at least about 10% by weight of the total oral composition. The flavor system may be used in the oral composition in a suitable amount less than about 20%, less than about 12%, less than about 10%, less than about 7%, less than about 5%, less than about 3%, less than about 2% by weight of the oral composition. Oral compositions may be products which in the ordinary course of usage are not intentionally swallowed for purposes of systemic administration of particular therapeutics agents, but are rather retained in the oral cavity for a time sufficient to contact substantially all the dental surfaces and/or oral tissues for purposes of oral activity. Methods of preparing the oral compositions may include mixing the flavor system by conventional methods to an oral delivery agent. Oral delivery agents include, but are not limited to, a toothpaste, mouth rinse, liquid dentifrice, gum, lozenges, liquid spray, and edible films. Toothpaste may be paste or gel formulations unless otherwise specified. The amount of flavor system added depends on the particular oral composition to which it is added. For example, chewing gums may include at least about 0.5%, more suitably at least about 2% wt/wt of flavor system while edible oral films may comprise at least about 6%, more suitable at least about 10% wt/wt of the flavor system due to their very low weight. The oral compositions comprise a sufficient amount of the flavor system to provide antimicrobial activity.

The beverages or flavor systems may include sweeteners as described above. Further, the beverages or flavor systems may include other antimicrobial agents. The beverages or flavor systems may also contain other flavoring agents, if desired. The flavoring agents may include essential oils, synthetic chemicals or natural chemicals or mixtures thereof including, but not limited to, oils derived from plants and fruits, such as citrus oils, fruit essences, peppermint oil, spearmint oil, other mint oils, clove oil, oil of wintergreen, anise and the like. Artificial flavoring agents and components may also be used. Natural and artificial flavoring agents may be combined in any sensorially acceptable fashion. Flavoring may include a cooling agent to enhance the flavor and perceived freshness.

The oral compositions may be chewing gums or any variation including, but not limited to, bubble gums, pellets, gum balls, sticks and tablets. Chewing gums may be coated or not coated and be of a variety of flavors, shapes and sizes. A chewing gum composition includes a gum base, and a suitable amount of the flavor system as described above. Chewing gum may be manufactured by any suitable conventional method. The base for the chewing gum includes an elastomer of a type normally employed in chewing gums, e.g., chicle, gum, jelutong, balata, crown gum, gutta-percha, sorva, butadiene-styrene copolymer, polyisobutylene, isobutylene-isoprene copolymer, polyethylene, and the like or mixtures thereof. Softeners may be added to chewing gum in order to optimize the chewability and mouth-feel of the gum. Chewing gums may include at least about 0.1%, at least about 0.5%, at least about 1%, at least about 2% of the flavor system. Chewing gums may include less than about 3%, less than about 2.5%, less than about 2% of the flavor system.

The flavor systems may be used in beverages. Beverages may include, but are not limited to, soft drinks, infant formula, coffee, tea, juice, water, flavored water or other liquids. The flavor systems may be used in the preparation of beverages by the addition of the flavor system at amounts of at least about 0.05%, at least about 0.1%, at least about 0.2%, at least about 0.5%, at least about 0.8%, at least about 1%, at least about 2%, at least about 3%, and at least about 4% by weight of the total beverage. The flavor systems may be used in the preparation of beverages by the addition of the flavor system at amounts of less than about 80%, less than about 70%, less than about 60%, less than about 50%, less than about 40%, less than about 30%, less than about 20%, less than about 15%, less than about 10%, less than about 8%, less than about 7%, less than about 6%, and less than about 5% by weight of the total beverage. As shown in the Examples, minimal inhibitory concentrations (MIC) may be tested against organisms commonly found in spoiled beverages such as Zygosaccharomyces bailii, Saccharomyces cerevisiae, and Alicyclobacillus acidoterrestis. These organisms may be resistant to preservatives and may be the most common problematic organisms in beverages such as juices as well as carbonated and non-carbonated drinks. The beverage product may comprise at least about 10%, about 15%, about 20%, about 25%, about 30%, about 35%, about 40%, about 50%, about 55%, about 60%, about 65%, about 70%, about 75%, about 80%, about 85%, about 90%, about 95% by weight water.

Many of the natural botanical extracts may be sparingly soluble in water. As such, a delivery system may be employed for use of the botanical extracts in liquid. A delivery system may comprise an emulsion, microemulsion, or nanoemulsion formed by emulsifiers such as modified starches, gum Arabic, and surfactants such as nonionic surfactants such as polysorbates such as polysorbate 80. Other emulsifiers or surfactants may be used such as polyglycerol esters, sucrose esters, Quillaja saponins (Q-Naturale from National Starch), and ionic surfactants such as lauric arginate, lecithin, and Diacetyl tartaric acid esters of monoglycerides (DATEM) and lecithins. In certain embodiments, the emulsifier is Mirenat™ (based on lauroyl arginate ethyl, available from Vedeqsa Inc, Barcelona, Spain)). The emulsifier may be a surfactant with a high hydrophilic-lipophilic balance (HLB) from 8-18. HLB values may be found, for example, in McCutcheon's Emulsifiers & Detergents (2009, MC Publishing Company, Glen Rock, N.J.). The emulsifiers may be used alone or in combination at different ratios ranging from, for example, 100:1, 10:1, 5:1, and 1:1. Emulsions and nanoemulsions may be formed using homogenization (low pressure and high pressure respectively). Microemulsions may be formed with a greater emulsifier concentration and mixing, and homogenization may not be required. Low-pressure homogenization may be about 2000 to about 4000 psi. High pressure homogenization may be about 8,000 to about 20,000 psi, or about 10,000 to about 30,000 psi.

For example, emulsions and nanoemulsions may be formed by adding 1) an oil phase oil soluble extract comprising natural botanical extracts (about 1-30% wt, in some embodiments suitably about 15-20% wt, suitably 0.1-10% wt), at least one oil soluble emulsifier or surfactant (about 1-10% wt, suitably about 1-5%, suitably about 5-8% in some embodiments, and suitably about 3-10% wt in some nanoemulsions) and the balance water, with 2) a water phase comprising about 1-25% wt water-soluble emulsifier or surfactant and the balance water. The oil phase and water phase are mixed using sheer mixing. Low-pressure homogenization (about 2000 psi to about 4000 psi) may be used for emulsions, while high-pressure homogenization or microfluidization (e.g., using 3 to 6 passes through a microfluidizer or high pressure homogenizer) may be used to produce the nanoemulsion at pressures from about 10,000-30,0000 psi. For the microemulsion, a concentration of the surfactant or emulsifier mixture may range from about 1-30%, about 10-18%, and about 14-16% wt with an oil concentration varying from about 0.1-10% wt. For the formation of microemulsion, the surfactant or emulsifier may be dispersed in water initially and then the oil may be slowly added while mixing. A natural botanical extract may be applied to juice, carbonated or still beverage as an emulsion, nanoemulsion, and microemulsion or by dispersing the natural botanical extracts in an alcohol such as ethanol. The concentration of the emulsions may vary depending on the botanical extract used. For example, the beverages may comprise less than about 1%, less than about 0.5%, or less than about 0.2% of the emulsions or ethanol solution.

In another embodiment, the botanical extract may be dispersed in an alcohol (e.g., ethanol) and then added to a beverage.

U.S. Publication No. 2009/0226549, which published on Sep. 10, 2009, is hereby fully incorporated by reference.

The following examples further describe and demonstrate embodiments within the scope of the present application. These examples are given solely for the purpose of illustration and are not to be construed as limitations of the present application as many variations thereof are possible without departing from the spirit and scope.

### EXAMPLES

All percentages described in the following examples are percent weight unless indicated otherwise.

### Example 1

Dry thyme leaves were milled on a hammermill with a 3 millimeter screen to increase the surface area and rupture the leaves. 28 kg of dry milled thyme leaves were added to 8.4 kg of water and mixed in a ribbon mixer until homogenous, about 5 minutes. The moistened thyme leaves were added to a stainless steel extraction column. Each extraction column was loaded with 28 kg dry thyme leaves. Three extraction columns were used. Liquid CO₂ was injected with 1 kg/hr of ethanol (96 A % natural fermentation grade), the CO₂ provided to the extractor at a rate of 250 kg/hr for 4 hours per extraction column under 45 atmosphere pressure at 7° C.+1°. The CO₂-ethanol-thyme extract was collected and passed through a heat exchanger which vaporizes the CO₂ to produce an ethanol-thyme extract to yield about 17% the weight of the initial leaves at this stage. The ethanol-thyme extract was processed by low vacuum distillation at 35° C. at 200 mbar to remove the ethanol in a batch still. The distilled thyme-extract was then treated on a thin-film molecular distillation unit (KD5 model, UIC GmbH of Germany) under vacuum pressure of 10⁻⁶ atmospheres at 100° C. at a flow rate of 1 kg per hour. The thyme extract was analyzed by mass spectroscopy and an exemplary list of the chemical composition of the thyme extract is shown in Table 1.

TABLE 1
Thyme extract

| Compound | % |
|---|---|
| Ethanol | 5.03 |
| Acetic Acid | 0.349 |
| 1-octen-3-ol | 1.031 |
| p-cymene | 6.382 |
| Eucalyptol | 0.43 |
| Linalool | 2.354 |
| Camphor | 0.232 |
| Boreol | 1.423 |
| 4-terpineol | 0.542 |
| thymol methyl ether | 0.701 |
| carvacrol methyl | 1.141 |
| ether | |
| Thymol | 58.468 |
| Carvacrol | 4.436 |
| Eugenol | 0.589 |
| beta-caryophyllene | 1.326 |
| caryophyllene oxide | 0.794 |
| Total | 85.228 |

### Example 2

A flavor system was formulated using the components set forth in Table 2.

TABLE 2

| | | % material |
|---|---|---|
| | | in final |
| | % material | flavor |
| Flavor B | in formula | system |
| Thyme extract (THYME SNO ™, Sensient | | 1-12% |
| Flavors, Indianapolis, IN) | | |
| Primarily composed of: | 1-50% | |
| Thymol | 0.01-5% | |
| Eugenol | 0.1-10% | |
| Carvacrol | | |
| Eucalyptol | | |
| Menthol crystals (Monarchy Aromatics, Ltd,) | | 15-50% |
| Peppermint oil (F.D. Copeland and Sons, Ltd) | | 25-60% |
| Natural Thymol | | 0.1-0.8% |
| TOTAL | | 100% |

The peppermint oil and menthol crystals were added together in a standard mixer and heated to 113° F. and mixed until homogenous. The mixture was then cooled and the thyme extract and natural thymol were added and mixed until homogenous.

### Example 3

A flavor system formulation was prepared using the following formulation in Table 3.

TABLE 3

| | | % material |
|---|---|---|
| | | in final |
| | % material | flavor |
| Flavor C | in formula | system |
| Thyme extract (THYME SNO ™, Sensient | | 5% |
| Flavors, Indianapolis, IN) | | |
| Primarily composed of: | 50% | |
| Thymol | | |
| Eugenol | | |
| Carvacrol | 7% | (2.5-3%) |
| Eucalyptol | | |
| Menthol crystals (Monarchy Aromatics, Ltd,) | | 40% |
| Peppermint oil (F.D. Copeland and Sons, Ltd) | | 55% |
| TOTAL | | 100% |

The peppermint oil and menthol crystals were added together in a standard mixer, heated to 113° F. until the menthol crystals dissolved, and the mixture was cooled. The thyme extract was then added to the mixture and mixed until homogeneous.

A batch of flavor system formulation C was analyzed by gas chromatography/mass spectrometry (GC/MS) using standard methods providing the main chemical composition of formulation C as shown in Table 4.

TABLE 4
Flavor C composition

| Compound | % |
|---|---|
| b-cymene | 0.376 |
| Eucalypto + Limonene | 2.892 |
| Menthone | 13.125 |
| Isomenthone | 2.798 |
| Menthofuran | 1.609 |
| Neomenthol | 2.317 |
| Menthol | 63.53 |
| Pulegone | 1.059 |
| Thymol | 2.506 |
| Methyl Acetate | 2.578 |
| Beta-caryophyllene | 1.038 |
| Germacrene | 0.416 |
| Other ingredients | 5.8 |
| Total | 100 |

### Example 4

A flavor system formulation was prepared as described in Example 3 but using the following formulation in Table 5.

TABLE 5

| | | % material |
|---|---|---|
| | | in final |
| | % material | flavor |
| Flavor D | in formula | system |
| Thyme SNO (THYME SNO ™, Sensient | | 9% |
| Flavors, Indianapolis, IN) | | |
| Primarily composed of: | 50% | |
| Thymol | | |
| Eugenol | | |
| Carvacrol | 7% | (2.5-3%) |
| Eucalyptol | | |
| Menthol crystals (Monarchy Aromatics, Ltd,) | | 38% |
| Peppermint oil (F.D. Copeland and Sons, Ltd) | | 53% |
| TOTAL | | 100% |

A batch of flavor system of formulation D was analyzed as described in Example 3. The formulation of the main chemical compositions of formula D can be found in Table 6.

TABLE 6
Flavor D composition

| Compound | % |
|---|---|
| b-cymene | 0.638 |
| eucalypto + Limonene | 2.623 |
| Menthone | 11.805 |
| Isomenthone | 2.53 |
| Menthofuran | 1.445 |
| Neomenthol | 2.122 |
| Menthol | 62.895 |
| Pulegone | 1 |
| Thymol | 4.963 |
| Methyl Acetate | 2.514 |
| Beta-caryophyllene | 0.97 |
| Germacrene | 0.379 |
| Other | 6.116 |
| Total | 100 |

### Example 5

### Chewing Gum Containing Flavor Systems

Chewing gum compositions are prepared by incorporating the flavor systems of Examples 3 and 4 with a chewing gum (Trident gum manufactured by Cadbury Adams located in Parsippany N.J.). The flavor systems are added at 2% weight of the composition of the gum.

### Example 6

### Liquid Filled Chewing Gum

Liquid filled chewing gum compositions, Dentyne Ice (manufactured Cadbury Adams located in Parsippany N.J.), are prepared by incorporating the flavor systems of Examples 3 and 4, the liquid portion of Dentyne Ice gum filling is mixed with 0.1% of the flavor system and the solid portion of the Dentyne Ice gum base is mixed with 3% of the flavor system.

### Example 7

### Liquid Filled Chewing Gum

Liquid filled chewing gum compositions, Dentyne Ice (manufactured by Cadbury Adams located in Parsippany N.J.), are prepared by incorporating the flavor systems of Examples 3 and 4, the liquid portion of Dentyne Ice gum filling is mixed with 1.0% of the flavor system and the solid portion of the Dentyne Ice gum base is mixed with 3% of the flavor system.

### Example 8

### Mouth Rinse Containing Flavor System

Mouth rinse compositions are prepared by mixing 2% by weight of the flavor systems of Examples 3 and 4 with a mouth rinse.

### Example 9

### Toothpaste Containing Flavor System

Toothpaste compositions are prepared by mixing 2% of flavor systems of Examples 3 and 4 with unflavored toothpaste until the mixture is homogenous.

### Example 10

### Edible Film Containing Flavor System

Edible film compositions are prepared by mixing 10% by weight of the flavor systems of Examples 3 and 4 with a substance to form an edible film.

### Example 11

### Composition of Thyme Extract

The composition of the thyme extract (THYME SNO™) obtained by ethanol CO₂ extraction process was analyzed as described in Example 3. An exemplary list of the chemical composition is shown in Table 7.

TABLE 7
Thyme extract

| Compound | % |
|---|---|
| Ethanol | 5.03 |
| Acetic Acid | 0.349 |
| 1-octen-3-ol | 1.031 |
| p-cymene | 6.382 |
| Eucalyptol | 0.43 |
| Linalool | 2.354 |
| Camphor | 0.232 |
| Boreol | 1.423 |
| 4-terpineol | 0.542 |
| thymol methyl ether | 0.701 |
| carvacrol methyl ether | 1.141 |
| Thymol | 58.468 |
| Carvacrol | 4.436 |
| Eugenol | 0.589 |
| beta-caryophyllene | 1.326 |
| caryophyllene oxide | 0.794 |
| Total | 85.228 |

### Example 12

### Antimicrobial Activity of Flavor System

In vitro studies were preformed at Indiana University School of Dentistry at the Indiana University-Purdue University of Indianapolis (IUPUI) to test for the antimicrobial activity of the flavor systems. Porphyromonas gingivalis (PG, ATCC 33277), Actinomyces viscosus (AV, ATCC 19246), Actinomyces naeslundii (AN, ATCC 12104), Streptococcus mutans (SM, ATCC 25175), and Fusobacterium nucleatum (FN, ATCC 31647) were used to determine the minimum inhibitory concentration of 4 different flavor systems, A-D. Thyme extract is Flavor A as described in Example 8, and flavor systems B-D are as described in Examples 2-4. The four flavor systems were provided in an undiluted form and each flavor system was diluted to the working test solutions of 1.0%, 0.5%, 0.05%, and 0.001% (v/v) flavor system. Each testing system had a final volume of 2.0 ml, each containing at least 1×10⁶ bacteria, adequate amount of the flavor system to obtain the working test solution, 1 ml of double strength enriched trypticase-soy broth and saline solution to bring the final volume up to 2 ml. Each test was run in triplicate.

Each testing sample was vigorously vortexed for 30 to 60 seconds to enhance physical contact of the bacteria with the relatively insoluble test products. A 1.0 ml aliquot was taken and placed into a flask containing 250 ml of Trypticase Soy Broth (TSB) supplemented with 0.25% (w/v) glucose. Flasks containing Porphyromonas gingivalis or Fusobacterium nucleatum were incubated at 37° C. in an anaerobic chamber (85% N₂-10% CO₂-5% H₂), while the other bacteria flasks were incubated at 37° C. in ambient air. Samples were evaluated after 24 hours. The minimal inhibitory concentration (MIC) was determined as the test sample with the greatest dilution that exhibited no bacteria growth (e.g., remained clear, not turbid). MIC scores for each of the flavor systems for each of the bacteria tested are shown in Table 8.

TABLE 8

| Flavor | FN | AN | AV | PG | SM |
|---|---|---|---|---|---|
| A | 0.05% | 0.05% | 0.05% | <0.01% | 0.05% |
| B | 0.05% | 0.1% | 0.5% | 0.05% | 0.5% |
| C | 0.05% | 0.5% | 0.1% | 0.05% | 0.1% |
| D | 0.1% | 0.1% | 0.5% | 0.05% | 1% |

### Example 13

### Flavor Release from Chewing Gum

To test if adequate flavor is released from chewing gum, the chewing gums made in Example 5 were tested using a mechanical instrument to simulate human mastication of chewing gum, which can be found in Kleber et al. A mastication device designed for the evaluation of chewing gum is set forth in Journal of Dental Research, 1981, 109-114, which is incorporated herein in its entirety. Artificial saliva (15 ml) was placed in the reservoir, and the thermostatically controlled heating element was turned on to maintain the saliva and gum at body temperature for proper chewing consistency. One stick of test chewing gum (approximately 3 grams with 2% flavor system added) was placed in the warmed chamber and the artificial saliva was exposed to the chewing gum for 1 minute under chewing simulation conditions. All the artificial saliva (15 ml) was removed as quickly as possible with a pipette, delivered immediately into a glass bottle and sealed. The saliva was replaced with a fresh 15 ml aliquot, the chewing conditions restarted and the gum samples were treated for another minute. This process was repeated at the appropriate intervals to yield cumulative treatment times of 1, 2, 5, 10, 15, 20 and 30 minutes. The reservoir and mastication devices were thoroughly cleaned and rinsed, and the process repeated with another sample of chewing gum.

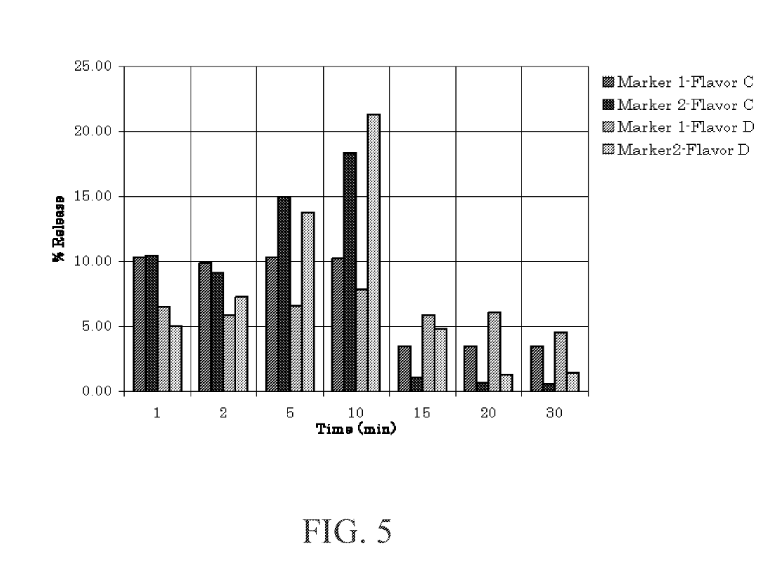

Two markers, Marker 1, thymol, and Marker 2, menthol, were selected to monitor flavor release based on quantity and antimicrobial efficiency. FIG. 5 shows release of the two markers at different predetermined times. Based on marker release, it was estimated that most of the flavor was released for Marker 2 between 5 and 10 minutes of chewing. Marker 1 was released constantly for the first 10 minutes and afterward decreases. Marker 2 was released at 55% in flavor C and flavor D while 40.8% and 33% of Marker 1 was released from flavor C and D respectively. It was estimated that enough flavor was released during the first 15-20 minutes to have antimicrobial activity based on the quantity released and the MIC results.

### Example 14

Dry thyme leaves were milled on a hammermill with a 3 millimeter screen to increase the surface area and rupture the leaves. 28 kg of dry milled thyme leaves were added to 8.4 kg of water and mixed in a ribbon mixer until homogenous, about 5 minutes. The moistened thyme leaves were added to a stainless steel extraction column. Each extraction column was loaded with 28 kg dry thyme leaves. Three extraction columns were used. Liquid CO₂ was injected with 1 kg/hr of ethanol (96 A % natural fermentation grade), the CO₂ provided to the extractor at a rate of 250 kg/hr for 4 hours per extraction column under 45 atmosphere pressure at 7° C.+1°. The CO₂-ethanol-thyme extract was collected and passed through a heat exchanger which vaporizes the CO₂ to produce an ethanol-thyme extract to yield about 17% the weight of the initial leaves at this stage. The ethanol-thyme extract was processed by low vacuum distillation at 35° C. at 200 mbar to remove the ethanol in a batch still. The distilled thyme-extract was then treated on a thin-film molecular still (KD5 model, UIC GmbH of Germany) under vacuum pressure of 10 ⁻⁶ atmospheres at 100° C. at a flow rate of 1 kg per hour.

### Example 15

An anti-microbial spray dried flavor formulation was prepared by mixing water and a starch-based encapsulating agent such as Hi-Cap 100 (National Starch, Bridgewater, N.J., U.S.A.). An oil flavor system was prepared as described in Example 3 except with the formulation according to Table 9. The oil flavor system was added to the starch and water to form an emulsion at a concentration of 16% (wt/wt) flavor system, 24% (wt/wt) Hi-Cap 100, and 60% (wt/wt) water with an average particle size of about 0.5 □m. The emulsion was then spray dried with an inlet temperature of about 160° C.

TABLE 9

| | | |
|---|---|---|
| | | % material |
| | | in final |
| | % material | flavor |
| Flavor E | in formula | system |

| | |
|---|---|
| Thyme SNO (THYME SNO ™, Sensient | 50% |
| Flavor, Indianapolis, IN) | |
| Menthol crystals (Monarchy Aromatics, Ltd,) | 0% |
| Peppermint oil (F.D. Copeland and Sons, Ltd) | 50% |
| TOTAL | 100% |

The final spray dried formulation was made into a volatile oil composition and analyzed with GC-MS. The chemical composition is shown in Table 10. Encapsulation of the flavor system removed water and some (about 20-60%) of the volatile oils from the formulation, resulting in about 40% load encapsulation.

TABLE 10
Anti-M Spray Dried

| Anti-microbial | |
|---|---|
| Compound | % |
| Carvacrol | 1% |
| Thymol | 12.098% |
| Eugenol | 0.25% |
| Eucalyptol | 2% |
| Menthol | 8.75% |
| (from peppermint oil) | |
| Other compounds | 75.902% |
| Total | 100% |

The anti-microbial spray dried flavor formulation may be incorporated into compositions such as water, chewing gums, toothpaste, mouth rinse, liquid dentifrice, lozenges, liquid spray, beverages, and edible films.

### Example 16

A breath freshening spray dried flavor formulation was prepared by mixing water and a starch-based encapsulating agent such as Hi-Cap 100 (National Starch, Bridgewater, N.J., U.S.A.). The oil flavor system as prepared and described in Example 3 (5% THYME SNO™, 40% menthol crystals, 55% peppermint oil) was added to the starch and water mixture to form an emulsion at a concentration of 16% (wt/wt) flavor system, 24% (wt/wt) Hi-Cap 100, and 60% (wt/wt) water with an average particle size of about 0.5 □m. The emulsion was then spray dried with an inlet temperature of about 160° C.

The final spray dried formulation was made into a volatile oil composition and analyzed with GC-MS. The chemical composition is shown in Table 11. Encapsulation of the flavor system removed water and some (about 20-60%) of the volatile oils from the formulation, resulting in about 40% load encapsulation.

TABLE 11
Breath Freshening Spray Dried

| Anti-microbial | |
|---|---|
| Compound | % |
| Menthol | 22.891% |
| Thymol | 1.17% |
| Eucalyptol | 0.5% |
| Carvacrol | 0.5% |
| Other compounds | 74.939% |
| Total | 100% |

The breath freshening spray dried formulation may be incorporated into compositions such as water, chewing gums, toothpaste, mouth rinse, liquid dentifrice, lozenges, liquid spray, beverages, and edible films.

### Example 17

### Determination of Botanical Extract MIC

Extraction Procedures

Extracts used in this study were produced by using subcritical CO₂ without and with alcohol or medium chain triaglycerols as entrainers. Extracts were further purified by molecular distillation at three different temperatures, 80° C., 100° C. and 120° C. Extracts were analyzed by GC-MS.

Natural Extracts Analysis

Each sample (0.5 μL) was directly injected to Agilent 6890 gas chromatography (GC) equipped with Agilent 5973 mass selective detector (MSD; Agilent, Palo Alto, Calif.). Separation column installed a ZB-1 capillary column (Phenomenex; Torrance, Calif.) with following dimensions: 30 m length×0.25 mm i.d.×1.00 μm film thickness (df). Temperatures of GC were as: injection port, 250° C.; oven temperature was programmed at 70° C. for 2.00 min, 4° C./min of the first ramp rate to 150° C. for 1.00 min holding time, and 8° C./min of the second ramp rate to 250° C. for 20.00 min holding time. Total running time was 57.50 min. The mode of flow was constant (1.0 mL/min). MSD conditions were as follows: interface temperature, 280° C., ionization energy, 70 eV; mass range, 15-400 a.m.u. and 1.00 min solvent delay. Helium (Ultra high purity) was used as carrier gas at a constant flow rate of 1.00 mL/min. The mode inlet was split (100:1 ratio). Volatile compounds were identified using the Wiley275, GRAS, and NIST98 Mass Spectral Databases. The identified volatile compounds were selected over 85% matching qualities between libraries and sample.

Bacteria Cultures

One strain of the spoilage yeast Zygosaccharomyces bailii NCYC 563 and Saccharomyces cerevisiae NCYC 505 were obtained from the National Collection of Yeast Cultures (Norwich, UK). Working cultures were maintained on slants stored at 4° C. A loopful of the culture was transferred to Malt Extract Broth (MEB) (Difco Laboratories, Sparks, Md.), and incubated at 25° C. for 48 h. Prior to exposure to antimicrobials, each strain was sub-cultured in MEB for 48 h.

Growth Curves

Enumeration of inocula was carried out by growth curves. Bacterial cultures were maintained on slants stored at 4° C. A loopful of the culture was transferred to MEB (pH of 4.7). Then plating the culture was carried out by plate dilution assay. Yeast extract and glucose Agar (YEGA) (Oxoid, Cambridge UK) at pH of 3.5 containing 0.5% of yeast extract and 2% of glucose were used. The pH was adjusted by adding 80% lactic acid.

Spot Inoculation Test

Solutions of the CO₂ extracts and MD extracts according to Table 12 were prepared using methods according to the application and the same as or similar to Example 1. The extracts and further purified extracts were prepared at 40% (w/v) in 96% ethanol, except the water soluble extracts were dissolved in water (Grape seed, Oolong and green tea).

Antimicrobial activity was measured by determining the MIC by spot inoculation at pH 3.5. Petri dishes were prepared by adding the extract at different concentrations (0.0005, 0.001, 0.0025, 0.005, 0.0075, 0.01, 0.025, 0.05, 0.075, 0.1, 0.5, and 1%) in 20 mL of YEGA with a pH of 3.5 adjusted by adding 80% of lactic acid. Prior to exposure to the antimicrobial, a loopful of the working culture was transferred to low pH (3.2) MEB adjusted with citrate buffer, and incubated at 25° C. for 48 h. Control plates containing different ethanol concentrations without extracts were prepared. The Petri dishes were dried and 20 μL drops of the inocula were plated to give a final concentration of ˜10⁴ CFU/mL. Experiments were replicated twice.

The growth curves at 48 h, which is the time that the organism was incubated before exposure to the antimicrobial, showed a growth for S. cerevisiae of 107 CFU/mL and for Z. bailii 108 CFU/mL. This showed that both organisms grew in that media, temperature, and pH (3.2).

MIC data for these extracts are shown in Table 12. For example, allspice MIC against Saccharomyces cerevisiae was 500 mg/kg (ppm), while allspice MIC against Zygosaccharomyces bailii was 750 mg/kg (ppm). Each extract had its own MIC specific to the organism tested ranging from 50 ppm to 5000 ppm. Above 5000 ppm the antimicrobial activity is not strong enough and therefore considered unsuitable for most applications.

The efficacy of the oils depended on the type of yeast. S. cerevisiae was more sensitive than Z. bailii. The most antimicrobial extract was cassia, but lower concentration need to be tested in order to determine the exact MIC. Nutmeg showed no antimicrobial activity against these two yeasts. Allspice showed a good antimicrobial activity but a difference between the extraction methods, the MD extracts were more effective than the CO2 counterpart. The MIC of each the different oils after 48 h are shown in Table 12. The cassia bark extracts were the most effective oil against both yeasts followed by allspice, thyme, sage, and clove.

TABLE 12

| | MIC (mg/kg) | |
|---|---|---|
| | Saccharomyces | Zygosaccharomyces bailii |
| Extract Concentration | cerevisiae NCYC 505 | NCYC 563 |
| Cassia CO₂ extract | 75 | 50 |
| Cassia MD extract | 50 | 50 |
| Allspice CO₂ extract | 750 | 1000 |
| Allspice MD extract | 500 | 750 |
| Nutmeg CO₂ extract | No Inhibition at 10,000 | No inhibition at 10,000 |
| Nutmeg MD extract | No Inhibition at 10,000 | No inhibition at 10,000 |
| Grape Seed (water Soluble CO₂) | No inhibition up to 500 | No inhibition up to 500 |
| Grape Seed (oil Soluble CO₂) | No inhibition up to 500 | No inhibition up to 500 |
| Clove (XXX) | 750 | 750 |
| Green Tea (water sol) | No inhibition up to 5,000 | No inhibition up to 5,000 |
| Oolong Tea (water sol) | No inhibition up to 5,000 | No inhibition up to 5,000 |
| Thyme MD extract | 500 | 500 |
| Sage | 500 | No inhibition up to 5,000 |
| Rosemary | No inhibition up to 5,000 | No inhibition up to 5,000 |
| Sandalwood | 750 | No inhibition up to 5,000 |
| Celery Seed | 1000* | 5,000* |

CO₂ extracts were obtained by liquid CO₂ extraction techniques that were the same or similar to Example 1. MD extracts were obtained by molecular distillation that was the same or similar to Example 1.

### Example 18

### Beverages Containing a Flavor System

Extracts according to Example 17 are separately incorporated into the beverages identified below. The oil phase containing the extract (in amounts between 0.1-10% wt) and an oil-soluble emulsifier or surfactant (for example, lecithin, Q-Naturale or lauric arginate in amounts between 1-20% wt) are added into a water phase containing water-soluble emulsifier or surfactant (for example, lecithin, Q-Naturale or lauric arginate) with sheer mixing. Low-pressure homogenization (3000 psi) is used to create the emulsion. The emulsion containing the extract is added to each of the beverages identified below separately at concentrations of 0.1% to 1.0% wt (for example, 0.1%, 0.2% and 0.5% wt).

| | % w/w |
|---|---|
| Isotonic | |
| Water | 94.5 |
| Salt | 0.086 |
| Sodium | 0.056 |
| citrate | |
| potassium | 0.04 |
| Sugar | 5 |
| sucralose | 0.008 |
| citric acid | 0.2 |
| Flavor | 0.04 |
| benzoate | 0.02 |
| Total | 99.95 |
| 10% juice | |
| drink | |
| Water | 83.6 |
| Pear juice | 1.5 |
| (70B) | |
| Grape juice | 0.2 |
| (68B) | |
| HFCS 42 | 14.2 |
| Citric | 0.24 |
| Flavor | 0.09 |
| Sodium | 0.09 |
| Citrate | |
| benzoate | 0.02 |
| total | 99.94 |
| Cola (1 + 5 | |
| fold) | |
| water | 27.5 |
| HFCS | 70.4 |
| Benzoate | 0.19 |
| Citrate | 0.01 |
| Caffeine/acid | 0.38 |
| Flavor | 1.5 |
| total | 99.98 |

### Example 19

### Emulsified Natural Extracts as Antimicrobials

A microemulsion is produced using small molecular surfactants as well as modifying the charge in order to increase the extract load. All extracts when received (Table 13) are characterized by GC-MS in order to identify their composition.

TABLE 13

| Extract | Code | Main Antimicrobial Component | Extraction Method |
|---|---|---|---|
| Cinnamon | C2516 | cinnaminc aldehyde, p-cymene, | CO₂ extract |
| | | eugenol | |
| Nutmeg | C1676 | carvacrol, p-cymene | CO₂ extract |
| Allspice | C1533 | eugenol, methyl ether cineol | CO₂ extract |
| Coriander | C1532 | d-linalool, d-a-pinene, b-pinene | CO₂ extract |
| Oolong tea | C2232 | polymeric polyphenol (fraction) | CO₂ extract |

Other SNO ™ s with Antimicrobial Activity

| | | | |
|---|---|---|---|
| Basil | C2306 | d-linalool, methyl chavioc, | CO₂ extract |
| | | eugenol, cineol, geraniol | |
| Bay | C2400 | cineol, l-linalool, eugenol, geraniol | CO₂ extract |
| Black Peppercorn | C1522 | piperine | molecular distillation |
| Black tea | C2065 | catechins (ECG, EGCG) and | CO₂ extract |
| | | teaflavins | |
| Carraway seeds | C2141 | carvone, limonene | CO₂ extract |
| Celery seeds | C1919 | d-limonene | CO₂ extract |
| Clove | C1671 | eugenol, cariofilene | CO₂ extract |
| Cucumber seeds | C2358 | amine fraction | CO₂ extract |
| Cumin | C2595 | cuminaldehyde, p-cymene | CO₂ extract |
| Garlic | C2794 | diallyl disulfide allicin, diethyl | solvent free oil |
| | | sulfide, diallyk trisulfate | extraction |
| Ginger | C2130 | gingerols | CO₂ extract or |
| | | | molecular distillation |
| Grape seed | — | activin | |
| Green tea | C2240 | nerolidol and caryophillene | CO₂ extract |
| Hops | C1522 | humulones and lupulones (a and | molecular distillation |
| | | b acids) | |
| Mint (garden) | C2791 | menthol, p-cymene, eucalyptol | CO₂ extract |
| Mustard | — | allyl-isothiocyanate | |
| Onion | C2805 | d-n-propyl disulfide, methyl-n- | solvent free oil |
| | | propyl disulfide | extraction |
| Oregano | C3185 | carvacrol, thymol, a-pinene, p- | CO₂ extract |
| | | cymene | |
| Rosemary | C2599 | borneol, cineol, camphor, a- | CO₂ extract |
| | | pinene, bornyl acetate | |
| Sage | C2308 | thujone, cineol, borneol, thymol, | CO₂ extract |
| | | eugenol | |
| Thyme | C3166 | thymol | CO₂ extract with |
| | | | molecular distillation |
| Vanilla | C1577 | vanillin, p-courmaric acid, p- | CO₂ extract |
| | | hydroxbenzoic | |

Microemulsion Preparation

Microemulsions are prepared by dispersing small molecule surfactants in water at different concentrations. A combination of surfactants are mixed at room temperature at different ratios (1/100, 1/10, 1/5, 1/1, 5/1, 10/1, 100/1, etc.). The natural extracts are titrated into the dispersed surfactant solution and then homogenized. Microemulsion oil capacity is determined using turbidity measurements. Also, stability is measured by adding the extract loaded-microemulsion into carbonated beverages and observing if any separation occurs. In addition, particle size and zeta potential is determined.

Nanoemulsion Preparation

Nanoemulsions are prepared by dispersing at least one surfactant or emulsifiers such as Q-Naturale, Mirenat™, and polysorbates in amounts of between 1-15% in water along with other water soluble components such as citric acid and sweeteners. The surfactant can be used individually or in combination with other surfactants or emulsifiers. The oil phase, containing the extract in amounts between 0.1-10% wt and an oil-soluble emulsifier or surfactant such as lecithin, will be added into the water phase while sheer mixing. High pressure homogenization, i.e. from 8,000-30,000 PSI, will be used to prepare the nanoemulsion. Multiple passes, i.e. from 3-12, are required to form the nanoemulsion or fine emulsion. Stability of the nanoemulsion is monitored by following particle size over time at different temperatures and by adding the loaded nanoemulsion to a beverage and observing if separation occurs over a period of time, i.e. 2-12 months. The particle size can be less than 200 nm, less than 100 nm or less than 50 nm. The particle size can be 50 nm.

Characterization and Stability

Maximum additive concentration or solubilization capacity. The MAC is defined as the highest concentration of a lipophilic material that could be incorporated into a surfactant solution at a given surfactant concentration. The MAC will be determined by measuring turbidity. As long as extract is capable of solubilizing, the solutions are expected to remain optically transparent. Above the MAC, solutions may become turbid due to the presence of excess the extract in the aqueous phase.

Creaming Index. Then grams of each microemulsion will be transferred into test tubes and will be stored for 7 days at room temperature and 40° C. After storage the creaming index (CI) will be measured. The total height of the emulsions (HE) and the height of the serum layer (HS) will be measured. The extend of creaming will be characterized by % serum=(HS/HE)×100.

Particle Size. Size changes in microemulsion yield important information about their stability. Dynamic Light Scattering (DLS) will be used to determine the size of the microemulsions and antimicrobial loaded microemulsions. The instrument determines the size of particles from the diffraction pattern with a 633 nm red laser and the detector set at a scattering angle of 173.

Zeta potential. Zeta potential is a critical parameter to determine functionality of mixed micelles as antimicrobial carrier systems is their charge. Positive charges could lead to increased interaction with negatively charged surfaces such as bacterial cell membranes, but may also lead to unintended interactions with other food components.

Antimicrobial Testing

Five concentrations (0.1, 0.5, 1, 2.5 and 5%) of extracts and two-emulsifier concentrations will be used (5% and 10%). The minimum inhibitory concentration (MIC) is defined as the minimum amount of antimicrobial needed to inhibit growth after 48 h of incubation. In order to save time spot inoculation assay will be used to identify the MIC. After the MIC has been identified growth curves can be done in order to detail more the inhibitory effect of the extract. The two organisms chosen in this study are microorganisms that are commonly found in the beverage industry.

Bacteria cultures. One strain of Acyclobacillus acidorrestris and Zygosaccharomyces bailii will be obtained from the American Type Culture Collection (ATCC®). Bacterial cultures will be stored at −75° C. in Malt extract broth (MEB) with 5% glycerol. Working cultures were maintained on slants stored at 4° C. A loopful of the culture was transferred to MEB, and incubated at 25° C. for Zygosaccharomyces bailii and 45° C. for Acyclobacillus acidoterrestris for 24 h. Prior to exposure to antimicrobials, each strain will be sub-cultured in MEB for 24 h.

Spot Inoculation Assay. A loopful of the working culture will be transferred to MEB, and incubated at the appropriated temperature for 24 h. Prior to exposure to antimicrobials, each strain will sub-cultured in MEB for 24 h. Petri dishes will be prepared by adding the microemulsion with or without the extract. They will be added in the Petri dish to give a desired concentration in 20 mL of melted temper Malt extract agar (MEA). This experimental design is based on single effects and all 2 factor interactions but neglect all higher order interactions. The Petri dishes will be dried and 10 μL drops of the inocula will be plated to give a final concentration of 105 CFU/mL. The extract and the microemulsions without extract were used as controls. To ensure that the extract will be equally dispersed in the plate a second control will be prepared by having the extract dispersed in 1% ethanol. Experiments will be done in duplicates and repeated three times.

We claim:

1. A flavor system comprising at least one of an emulsion, microemulsion or nanoemulsion comprising an herbal extract, wherein the herbal extract comprises at least one of thymol, cinnamic aldehyde, eugenol, carvacrol, eucalyptol, and a combination thereof.

2. The flavor system of claim 1, further comprising at least one of lecithin, polysorbate, Quillaja saponin, lauroyl arginate derivatives and a combination thereof.

3. The flavor system of claim 1, further comprising a water-soluble emulsifier with an HLB of about 7-18.

4. The flavor system of claim 1, wherein the herbal extract is extracted from an herb selected from the group consisting of thyme, oregano, clove, cilantro, cinnamon, ginger, lavender, allspice, basil, bay celery seed, pimento, lemongrass, parsley, onion, mustard, tarragon, sage, rosemary, coriander, marjoram, cumin, fennel, and black peppercorn.

5. The flavor system of claim 1, wherein the herbal extract has a minimum inhibitory concentration for at least one of Porphyromonas gingivalis, Actinomyces viscosus, Actinomyces naeslundii, Streptococcus mutans, Zygosaccharomyces Bailii, Saccharomyces cerevisiae, Brettanomyces bruxellensis, Alicyclobacillus acidoterrestris, and Fusobacterium nucleatum, and the minimum inhibitory concentration is less than about 3%.

6. The flavor system of claim 1, wherein the herbal extract comprises at least one of about 1 to about 60 wt % thymol, about 0.01 to about 80 wt % eugenol, about 0.1 to about 80 wt % carvacrol, about 0.01 to about 80 wt % cinnamic aldehyde, and a combination thereof.

7. A beverage product comprising the flavor system of claim 1.

8. The beverage product of claim 7, wherein the flavor system comprises about 1 to about 80 wt % herbal extract.

9. The beverage product of claim 7, wherein the beverage product comprises soft drink, carbonated soft drink, infant formula, coffee, tea, water, flavored water or juice.

10. A flavor system comprising an herbal extract having a minimum inhibitory concentration for at least one of Porphyromonas gingivalis, Actinomycess viscosus, Actinomyces naeslundii, Streptococcus mutans, Zygosaccharomyces Bailii, Saccharomyces cerevisiae, Brettanomyces bruxellensis, Alicyclobacillus acidoterrestris, and Fusobacterium nucleatum, wherein the minimum inhibitory concentration is less than about 3%.

11. The flavor system of claim 10, wherein the minimum inhibitory concentration is less than about 0.5%.

12. The flavor system of claim 10, wherein the herbal extract is extracted from an herb selected from the group consisting of thyme, oregano, clove, cilantro, cinnamon, ginger, lavender, allspice, basil, bay celery seed, pimento, lemongrass, parsley, onion, mustard, tarragon, sage, rosemary, coriander, marjoram, cumin, fennel, and black peppercorn.

13. The flavor system of claim 10, wherein the herbal extract comprises at least one of about 1 to about 60 wt % thymol, about 0.01 to about 80 wt % eugenol, about 0.1 to about 80 wt % carvacrol, about 0.01 to about 80 wt % cinnamic aldehyde, and a combination thereof.

14. The flavor system of claim 10, further comprising at least one characterizing flavor component is selected from the group consisting of flavor oils, menthol crystals, citrus oils, fruit essences, cinnamon, anise, and artificial and natural flavoring agents.

15. The flavor system of claim 10, further comprising at least one additional antimicrobial agent.

16. A beverage product comprising the flavor system of claim 10.

17. The beverage product of claim 16, wherein the flavor system comprises about 1 to about 80 wt % herbal extract.

18. The beverage product of claim 16, wherein the beverage product comprises soft drink, carbonated soft drink, infant formula, coffee, tea, water, flavored water or juice.

19. A method of making a beverage product comprising:
a) treating an herb with liquid CO₂ extraction to produce an herbal extract; and
b) combining the herbal extract with at least one of water, emulsifier, and surfactant to form a beverage product.

20. The method of claim 19, further comprising molecularly distilling the herbal.

21. The method of claim 19, wherein the liquid CO₂ extraction is at a temperature of less than about 25° C.

22. The method of claim 19, wherein the beverage product comprises soft drink, carbonated soft drink, infant formula, coffee, tea, water, flavored water, or juice.

23. The method of claim 19, wherein the liquid CO₂ extraction is in the presence of an alcohol to produce an alcohol-herbal extract.

24. A method of making a flavor system, the method comprising:
combining a water phase and an oil phase comprising an herbal extract under conditions sufficient to form at least one of an emulsion, a microemulsion and nanoemulsion.

25. A method of making a beverage product, the method comprising incorporating the flavor system made according to claim 24 into a beverage.

26. The method of claim 24, wherein the beverage comprises soft drink, carbonated soft drink, infant formula, coffee, tea, water, flavored water, or juice.
